(19) United States
(12) Patent Application Publication
(10) Pub. No.: US 2011/0154257 A1
(43) Pub. Date: Jun. 23, 2011

(54) SYSTEM AND METHOD FOR MANAGING CONTACT INFORMATION

(75) Inventor: YING SHI, Nanjing City (CN)

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/835,754

(22) Filed: Jul. 14, 2010

(30) Foreign Application Priority Data
Dec. 18, 2009 (CN) 200910311806.1

(51) Int. Cl. G06F 3/048

(52) U.S. Cl. 715/810

(57) ABSTRACT

A system for managing contacts in a communication device and related method can classify all contact information in the communication device, store the classified contact information to corresponding menus, and select a choice from the menus to acquire information of a contact. The system and method further permits users operating multiple menus to search all contact information in the communication device.

### BACKGROUND

1. Technical Field

Embodiments of the present disclosure relate to database management, and more particularly to a system and method for managing contact information.

2. Description of Related Art

Electronic systems and method for managing contact information are often searchable by entry. Often, users input the one or two letters from the alphabet to generate a list of candidates from the contact database, such as searching by the first alphabet in a contact database of the mobile phone. However, locating entries in a large number of candidates can be inconvenient.

### BRIEF DESCRIPTION OF THE DRAWINGS

FIG. 1 is a block diagram of one embodiment of a communication device comprising a contact information management system.

FIG. 2 is a block diagram of one embodiment of the contact information management system of FIG. 1.

FIG. 3 is a flowchart illustrating one embodiment of a method of managing contact information using a communication device.

FIG. 4a and FIG. 4b are schematic diagrams of the method of inquiring contact information using a communication device by one and two level classifications.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be embedded in firmware, such as an EPROM. It will be appreciated that module may comprise connected logic units, such as gates and flip-flops, and may comprise programmable units, such as programmable gate arrays or processors. The module described herein may be implemented as either software and/or hardware module and may be stored in any type of computer-readable medium or other computer storage device.

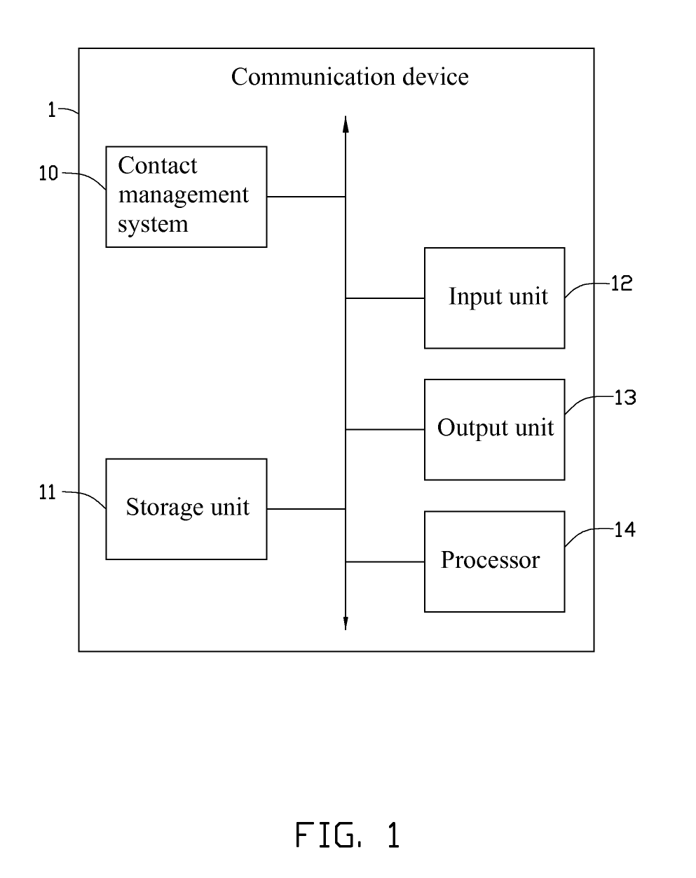

FIG. 1 is a block diagram of one embodiment of a communication device 1 comprising a contact information management system 10. The contact information includes names, addresses, phone numbers, email addresses, fax numbers, a priority information, groups and other contact information. There are often multiple pieces of information for each category of information. For example, phone numbers can include one or more home phone numbers, one or more business numbers and other phone numbers. Likewise, email addresses can include a plurality of email addresses. The contact management system 10 can manage contact information using the communication device 1 by multiple menus of a user interface of the communication device 1. For example, the contact management system 10 provides a group menu, a address menu, or a priority information menu for searching the contact information. In one embodiment, the communication device 1 further comprises a storage unit 11, an input unit 12, an output unit 13 and at least one processor 14. Depending on the embodiment, the communication device 1 may include electronic devices such as mobile phones, notebook computers, handheld game consoles, digital cameras, handheld computers or personal digital assistants (PDAs), for example.

The communication device 1 is generally controlled and coordinated by operating system software, such as UNIX, Linux, Windows 95, 98, NT, 2000, XP, Vista, Mac OS X, an embedded operating system, or any other compatible operating systems. In other embodiments, the electronic device 1 may be controlled by a proprietary operating system. Conventional operating systems control and schedule computer processes for execution, perform memory management, provide file system, networking, and I/O services, and provide a user interface, such as a graphical user interface (GUI), among other things.

The storage unit 11 is connected to the contact management system 10, the input unit 12, the output unit 13 and the processor 14. The storage unit 11 is operable to save the contact information. The contact information can include parameters such as names, phone numbers, groups and priority information. The storage unit 12 may include a hard disk drive, flash memory, RAM, ROM, cache, or external storage mediums.

The input unit 12 is operable to input by key selection or menu selection. For example, the input unit 12 can be a conversional keypad or a touch panel of a mobile phone.

The output unit 13 is a display listing of information, for example the contact information, as well as a graphic user interface (GUI) for providing input capability to the input unit 12. For example, the output unit 13 may be a display screen, a resistive touch screen, or a capacitive touch screen.

The processor 14 is operable to execute one or more computerized codes of the contact management system 10 may be stored in the storage unit 11 and executed by the processor 10. The processor, as an example, may include a CPU, math coprocessor, or shift register.

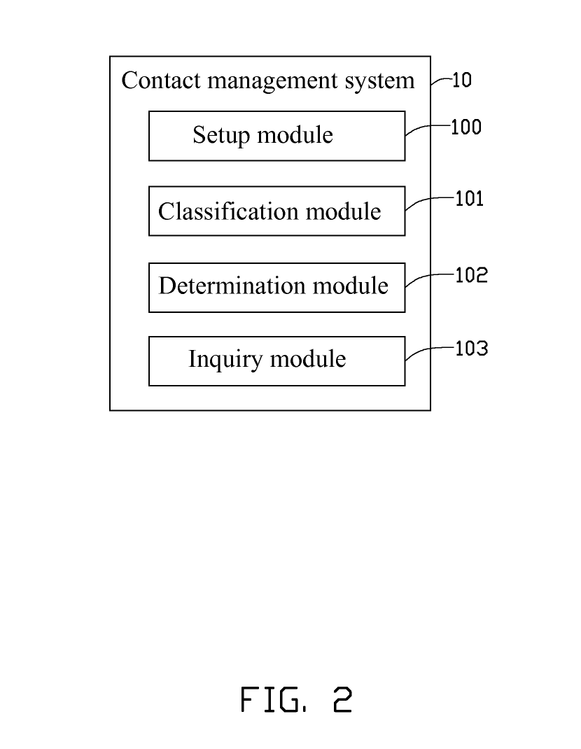

FIG. 2 is a block diagram of one embodiment of the contact information management system 10. The contact management system 10 includes a setup module 100, a classification module 101, a determination module 102 and an inquiry module 103. The setup module 100 is operable to set menu parameters of menus of a user interface of the communication device and generate at least one corresponding menu. The menu parameters include a level parameter for setting a level of the corresponding menu. In one embodiment, the corresponding menu is set to a one-level menu upon detecting the level parameter is set to 1. In other embodiments, the corresponding menus are set to two-level menus upon detecting the level parameter is set to 2. For example, the setup module 100 sets a level parameter 2 of the menu by the user inputting on the input unit 12, then the setup module 100 generates a two levels corresponding menus. Continually, the output unit 13 displays the contact information by the two levels corresponding menus, such as a name menu and a group menu.

In addition, the setup module 100 is operable to set corresponding classifications to the corresponding menus, such as classification by group, contact priority, and alphabetization. In one embodiment, if the corresponding menu is set to the one-level menu and the corresponding classification is set to the group classification, the corresponding one-level menu may be set to a family menu, a colleague menu, or classmate menu. In one embodiment, if the corresponding menu is set to the one-level menu and the corresponding classification is set to the classification in contact priority, the corresponding one-level menu may be set to a contact menu in the first priority, a contact menu in the second priority, or a contact menu in the third priority.

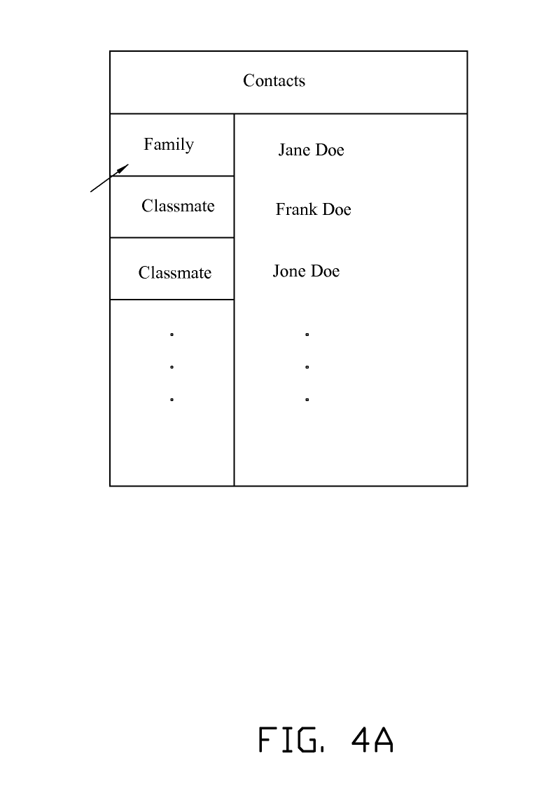

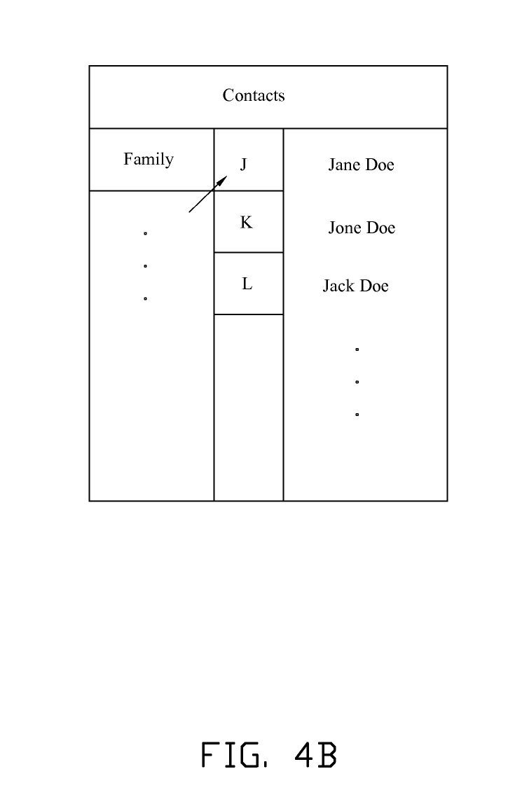

In other embodiments, if the corresponding menu is set to the one-level menu and the corresponding classification is set to the order classification in the first letter of the name, the corresponding one-level menu may be set to a first letter menu. For example, the first letter menu may be set to an A-letter menu including the contacts which names have the first letter A. Furthermore, if the corresponding menu is set to the multiple levels menus, the first corresponding classification is set to the first level menu at first. Then, the other corresponding classifications are set to the other corresponding menus in different levels menus. FIG. 4a shows a one-level menu set to group classification, such as family, colleagues, or classmates. FIG. 4b shows a two-level menu generated by setting the level parameter to 2. The group classification is set to the first level menu, and the order classification in the first character of the name is set to the second level menu.

The classification module 101 is operable to classify the contact information by the corresponding classifications and save the classified contact information to the corresponding menus. The contact information may include names, phone numbers, groups and priority information. In one embodiment, if the corresponding menu is set to the one-level menu and the corresponding classification is set to the group classification, the classification module 101 classifies the contacts which have a column value of the group equal to “family” to the family menu. In other embodiments, the corresponding menus are set to the two-level menus. Accordingly, the first level corresponding classification is set to the group classification and the second level corresponding classification is set to an order classification in the first letter of the name. The classification module 101 starts to classify contacts by the first level corresponding classification, then continues to classify each menu in the first level by the second level corresponding classification. For example, the classification module 101 starts to classify contacts by the family classification in first level corresponding classification, then continues to classify the first level classified contacts in the family menu by the order classification in the first letter of the name. As shown in FIG. 4b, the contact names of “Jane Doe” and “June Doe” are saved to the J menu in the second level menu respecting to the family menu between the first level menus.

The determination module 102 is operable to determine whether the contact management system 10 is currently conducting a search on the contact information. For example, The determination module 102 determines whether the inquiry module 103 is executed by the contact information management system 10.

The inquiry module 103 is operable to locate the contact information in the corresponding menu by the corresponding classification. In one embodiment, if the corresponding menu is set to the one-level menu in the communication device 1, the contact information is sought in the corresponding menu by the inquiry module 103. As shown in FIG. 4a, the contact information is sought in the family menu in the one-level menu by the inquiry module 103. The output unit 13 displays the contact information located in the family menu. As shown in FIG. 4b, when the corresponding menus are set to the two-level menus, if the user wishes to locate a contact who is a family member with a name beginning with “J”, the family menu is selected in the first level menu by the inquiry module 103, and the second level menu is accessed to select a “J” menu from the first level menu. The output unit 13 displays the contact information acquired from the family menu having a name beginning with “J”.

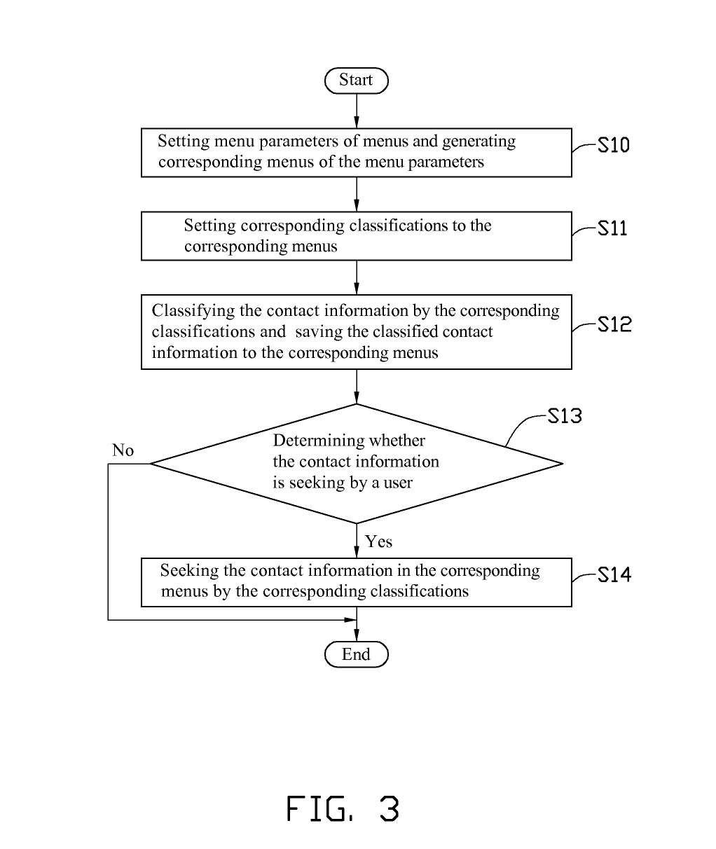

FIG. 3 is a flowchart illustrating an embodiment of a method for managing contact information using a communication device 1. Depending on the embodiment, additional blocks may be added, others deleted, and the ordering of the blocks may be changed.

In block S10, the setup module 100 sets menu parameters of the menus of a user interface of the communication device, then generates at least one corresponding menu. The menu parameters include a level parameter for setting a level of the corresponding menus. For example, the setup module 100 sets a level parameter 2 of the menu by the user inputting on the input unit 12, then the setup module 100 generates a two levels corresponding menus. Continually, the output unit 13 displays the contact information by the two levels corresponding menus, such as a name menu and a group menu.

In block S11, the setup module 100 sets corresponding classifications to the corresponding menus. The corresponding classifications include a group classification, a classification in contact priority, and an order classification in the first letter of the name. For example, if the corresponding menu is set to the one-level menu and the corresponding classification is set to the group classification, the corresponding one-level menu may be a family menu, a colleague menu, or classmate menu.

In block S12, the classification module 101 classifies the contact information by the corresponding classifications. In addition, the classification module 101 saves the classified contact information to the corresponding menus.

In block S13, the determination module 102 determines whether the contact management system 10 is currently conducting an inquiry. If not, block S14 is implemented and the inquiry module 103 seeks the contact information in the corresponding menu by the corresponding classification. If so, the process is ended.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A contact management system using a communication device, the communication device comprising a processor, an input unit, an output unit and a storage unit, the contact management system comprising:
a setup module to set menu parameters of menus of a user interface of the communication device, generate corresponding menus of the menu parameters, and set corresponding classifications to the corresponding menus;
a classification module to classify plurality of contact information by the corresponding classifications and to save the classified contact information to the corresponding menus; and
an inquiry module to seek the contact information in the corresponding menus by the corresponding classifications.

2. The contact management system of claim 1, wherein the menu parameters of the menus include a level parameter of the menu.

3. The contact management system of claim 1, wherein the contact information further includes names, phone numbers, groups, and a priority information.

4. The contact management system of claim 1, wherein the classification is a group classification, a classification in contact priority, or an order classification in the first letter of the name.

5. The contact management system of claim 4, wherein the group classification is a family classification.

6. A method for managing contact information using a communication device, the communication device comprising a processor, an input unit, an output unit and a storage unit, the method comprising:
setting menu parameters of menus of a user interface of the communication device and generating corresponding menus of the menu parameters;
setting corresponding classifications to the corresponding menus;
classifying the contact information by the corresponding classifications and saving the classified contact information to the corresponding menus;
determining whether the contact information is seeking by a user; and
seeking the contact information in the corresponding menus by the corresponding classifications.

7. The method of claim 6, wherein the step of setting menu parameters of the menus further sets a level of the menu.

8. The method of claim 6, wherein the contact information further includes names, phone numbers, groups and a priority information.

9. The method of claim 6, wherein the classification is a group classification, a classification in contact priority, or an order classification in the first letter of the name.

10. The method of claim 6, wherein the group classification is a family classification.

11. A storage medium having stored thereon instructions that, when executed by a processor, causes the processor to perform a method for managing contact information using a communication device, the communication device comprising a processor, an input unit, an output unit and a storage unit, the method comprising:
set menu parameters of menus of a user interface of the communication device and generate corresponding menus of the menu parameters;
set corresponding classifications to the corresponding menus;
classify the contact information by the corresponding classifications and save the classified contact information to the corresponding menus;
determine whether the contact information is seeking by a user; and
seek the contact information in the corresponding menus by the corresponding classifications.

12. The storage medium of claim 11, wherein the step of set menu parameters of the menus further sets a level of the menu.

13. The storage medium of claim 11, wherein the contact information further includes names, phone numbers, groups and a priority information.

14. The storage medium of claim 11, wherein the classification is a group classification, a classification in contact priority, or an order classification in the first letter of the name.

15. The storage medium of claim 11, wherein the group classification is a family classification.
